(19) United States
(12) Patent Application Publication
(10) Pub. No.: US 2007/0181253 A1
(43) Pub. Date: Aug. 9, 2007

(54) Image receiver media and printing process

(76) Inventors: Ming Xu, Mount Pleasant, SC (US); Sukun Zhang, Mount Pleasant, SC (US); Zhenrong Guo, Mount Pleasant, SC (US)

Correspondence Address: B. Craig Killough;Barnwell Whaley Patterson & Helms, LLC, P.O. Drawer H, Charleston, SC, 29402-0197, US

(21) Appl. No.: 11/413,734

(22) Filed: Apr. 28, 2006

Related U.S. Application Data
(60) Provisional application No. 60/765,446, filed on Feb. 3, 2006.
(60) Provisional application No. 60/790,886, filed on Apr. 11, 2006.

(51) Int. Cl. B41F 16/00

(52) U.S. Cl. 156/344; 101/483

(57) ABSTRACT

This invention is a process of printing or forming a resist layer over an area of a printed transfer medium that has binders or other materials thereon but is not covered by a printed image. The layer resists transfer to the final substrate of binder materials and other materials of the transfer medium that are not covered with the printed image.

Applicant claims the benefit of Application No. 60/765,446 filed Feb. 3, 2006.

Applicant claims the benefit of Application No. 60/790,886 filed Apr. 11, 2006.

### FIELD OF THE INVENTION

This invention relates to printing methods generally, and is more specifically directed to materials and a process of printing onto transfer medium, and subsequently transferring an image from the transfer medium to a substrate.

### BACKGROUND OF THE INVENTION

Transfer media are receivers for print media from which an image is subsequently transferred. Transfer media are commonly rectangular sheets in sizes such as A4 upon which one or more materials are coated. The transfer media may include a release layer that encourages release of the image to the substrate during transfer. The materials coated on the transfer media may be binder materials that bond the image to the final substrate upon which the image is to appear, which may be a textile.

Transfer media, such as thermal transfer paper, can transfer a heat-melt image to a final substrate such as cotton, with the binder materials from the transfer sheet holding the image layer on the final substrate. The binder materials from the entire sheet are transferred, and not just the binder materials that are associated with the image. The transferred binder material that is applied to the final substrate beyond the imaged area is very stiff to the touch, and is visible to the naked eye.

The use of computer technology allows substantially instantaneous printing of images. For example, video cameras or scanners 30 may be used to capture a color image on a computer 20. Images created or stored on a computer may be printed on command, without regard to run size. The image may be printed onto substrates from the computer by any suitable printing means capable of printing in multiple colors, including mechanical thermal printers, ink jet printers 24 and electrophotographic or electrostatic printers.

Computers and digital printers are inexpensive, and transfers of photographs and computer generated images may be made to T-shirts and other articles. These transfers may be produced by end users at home, as well as commercial establishments. For example, a digital image is printed on thermal transfer medium by an ink jet printer. The image is transferred from the thermal transfer paper by the application of heat, using an iron for clothing, or a heat press intended to accomplish such transfers.

Gross coverage of the transfer medium with the binder materials does not match the coverage of the image to be printed upon it. The material or materials are applied to the substrate of the transfer medium over the general area to which the image layer formed by the inks is to be applied. Application of the binder material on this substrate is typically performed during a manufacturing process, such as by spraying the material on the sheet which forms the substrate for the transfer medium.

To achieve sufficient coverage of the binder materials on the transfer medium, the area of the sheet that is covered with the surface coating material is larger than the area that will be covered by the ink layer that forms the image. The binder materials extend from and beyond the margins of the image after the image is applied to the substrate and are transferred to the final substrate. The binder materials can be seen on the final substrate with the naked eye as they surround the image, usually appearing as a rectangle that is beyond the edges of the image. The excess binder material reduces the aesthetic quality of the printed image on the substrate. Further, the non-imaged materials that are transferred tend to yellow with age, which is undesirable, particularly on white and other light colored substrates. Yellowing is accelerated with laundering (sometimes called re-deposition) and other exposure to heat, chemicals or sunlight.

Images transferred from thermal transfer sheets to textiles depreciate over time. The thermal transfer paper technology only creates a temporary bond between the transfer materials and the final substrate. This bond is not durable when repeatedly laundered. An improvement in the durability of this image is needed.

### SUMMARY OF THE INVENTION

This invention is a process of printing or forming a resist layer over an area of a printed transfer medium that is covered with binders or other materials, but is not covered by a printed image. The layer resists transfer to the final substrate of binder materials and other materials of the transfer medium that are not covered with the printed image.

### DESCRIPTION OF THE DRAWINGS

FIG. 1 is exemplary of a hardware system that may be used to practice the method of the invention.

FIG. 2a is a transfer medium that may be used to receive a printed image according to the invention.

FIG. 2b shows the transfer medium of FIG. 2a receiving a printed image.

FIG. 2c shows the transfer medium of FIG. 2b receiving a resist layer that is printed over the non-imaged areas of the transfer medium.

FIG. 2d shows the image being transferred from the transfer medium of FIG. 2a to a final substrate, with the non-imaged areas of the transfer medium remaining with the substrate.

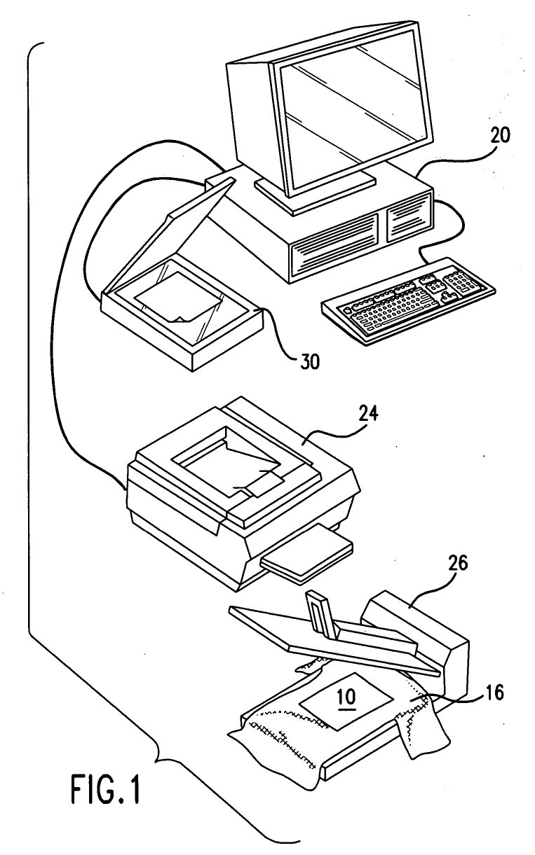

### DESCRIPTION OF THE PREFERRED EMBODIMENTS

In a preferred embodiment of the present invention, a computer-designed image is first digitally printed to a transfer medium, which may be a thermal transfer paper. After the resist layer is printed, the portion of the transfer paper that is covered with binders or other materials, but is not imaged, is printed with a resist layer. After the image is printed, a higher temperature is applied from the back of the transfer medium, preferably under pressure, to transfer the image from the transfer medium to a final substrate. The heat may simultaneously activate the image, and/or react components and bond and/or cross-link the final substrate and the colorants. The image is bonded to the substrate, and excellent durability can be achieved for the final design image that appears on the final substrate. Appropriate pressure is applied during the transfer process to ensure the proper surface contact between the medium and the final substrate. The binder materials that are present on the transfer medium that are not covered with an image are not transferred to the final substrate, since the resist layer prevents substantial transfer, or bonding of these materials, to the final substrate.

In one embodiment, the resist layer is formed of inorganic materials. The resist layer may be formed of a material comprising silica or alumina (Al₂O₃) and isopropyl alcohol. The resist layer is formed in one embodiment by printing the materials on the non-imaged areas of the transfer medium that have the binders and/or materials present, using an ink jet printer. Printing of the resist layer may be performed while the transfer sheet is in the printer and substantially at the same time that the image is printed on the transfer medium. The resist layer and image are allowed to dry if wet, and the transfer medium is positioned with the image against the final substrate. The image is transferred to the final substrate. The resist layer deters the polymer film or other bonding material previously coated or printed or otherwise applied to the transfer medium from mechanically attaching to a final substrate, such as a cotton T-shirt. The image is present on the final substrate. Materials on the transfer medium that serve to release the image from the transfer medium or to bond the image to the final substrate, and are not imaged, are not transferred to the final substrate.

When a single digital imaging device is used for the application of both color imaging materials and resist layer, the transfer medium receives the printed resist layer and imaging materials without altering their relative physical position to the device, and high resolution image quality may be achieved. In one embodiment, the two types of ink or toner are applied through different ink/toner cartridges or printing channels of the same device, yielding excellent image resolution and allowing the use of complex dithering software or firmware control in such applications. Extremely fine image lines, for example, of binder material, along with color ink or toner, can be produced that are limited in quality only by the resolution of the imaging device, and which cannot typically be matched by conventional analog printing methods.

In one embodiment, the transfer medium is a thermal transfer paper that comprises a release base paper or protective release layer. The transfer medium is printed or coated with relatively low glass transition temperature acrylic polymers, a polyester fine powder and/or a clear toner that comprises active hydrogen and materials that react with active hydrogen, and which may be blocked, as taught in U.S. patent application Ser. No. 10/638,810 (which is incorporated by reference), a liquid plasticizer and wax-like polymers. The transfer medium may also comprise textile polymers, bleed control polymers, ink absorbent materials and wax-like polymers.

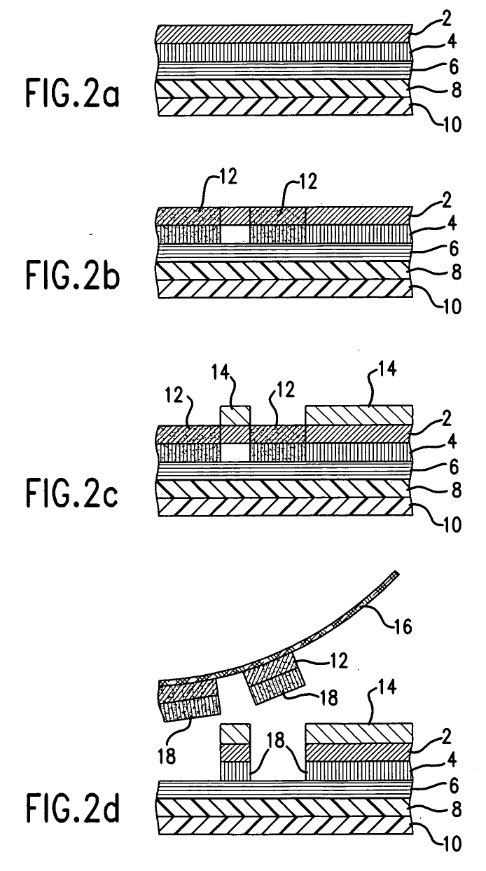

As shown in FIG. 2a, the transfer medium is a thermal transfer paper comprising a base sheet 8, an optional protective release layer 6, a binder layer 4 and an optional surface conditioning layer 2, which may be used to enhance image quality. The optional back coating 10 may be a polymer that controls the tension of the substrate. The base sheet may be a cellulose, paper, or plastic sheet of material. The optional protective release layer inhibits liquid components of the ink from being absorbed by the base sheet. The optional protective release layer may be formed by coating a polymeric resin, self-crosslinking resin, or a silicone release material, wax or wax-like material, with or without inorganic filler material, which may be talc, kaolin, or other pigments. The binder layer is formed as described herein.

In one embodiment, an image 12 is formed by an ink jet printer. FIG. 2b. The ink printed by the ink jet printer that forms the image may comprise dye or pigment, surface modified pigment such as Cabot pigment, sublimation dye, isocyanate, hydroxyl functional polymers and other additives. The ink may be prepared in C, M, Y and K, and made available to four channels of an ink jet printer for the purpose of preparing a full color image that may be transferred to a final substrate. The ink may be prepared as more fully described in U.S. patent application Ser. No. 11/113,663, and reference is craved thereto and the teachings thereof are incorporated herein.

When the resist layer 14 is digitally printed on the transfer medium, by, for example, a computer 20 driven inkjet 24 or electrophotographic printer, an accurate outline of the imaged area 12 can be achieved without having alignment errors. FIG. 2c. Alignment errors frequently occur with conventional analog imaging processes such as screen printing, particularly where the alignment is performed visually by the operator. Digital printing of the resist layer provides full coverage of the non-imaged binder layer 4, without the resist layer covering any portion of the imaged area 12, except for perhaps a small margin of coverage at the border between the imaged and non-imaged area. Digital printing of both the color image and the resist layer permit extremely high quality image transfers. The image printing step and the resist layer printing step may be carried out by the same digital printer if the printer has sufficient capacity, or the processes may be performed on separate digital imaging devices in which the relative positioning of the image and the resist layer is achieved by computer commands to the digital printer.

The imaged transfer medium with the resist layer printed thereon is positioned with the image 12 adjacent to the final substrate 16. FIG. 2d. The image and the associated binder layer 18 is transferred to the final substrate by application of heat or energy to the transfer medium, and typically, to the final substrate. Heat may be applied by a heat press 26. The resist layer prevents transfer of that portion of the binder layer 4 that is not imaged.

The material that forms the resist layer is prepared as a liquid that can be printed by an ink jet printer if used as part of a liquid ink jet process. The material is supplied to a printer having at least five channels if used in a full color ink jet process, with the other four channels providing C, M, Y, K. For example, in an eight-channel color printer, the colorless material for the resist layer can be placed in four channels, and the CMYK ink in the other four channels.

Other materials or chemicals may be used to form the resist layer. Depending upon the printer that is used to apply the resist layer, either liquid, or solid hot melt materials, or a combination may be used, as long as the final ink or toner can be applied through the printer. For instance, wax, or wax-like polymeric materials may be used if a thermal transfer printer is used to generate the resist layer; or non-binding polymeric resin materials may be used if an electrophotographic (laser) imaging device is used. Toner powder may be used in solid forms with electrographic printing.

When an ink jet device is used to print the resist layer, the release materials or chemicals may comprise liquid silicon based polymeric resins, surfactants or the like. High boiling temperature solvents, or humectants, especially those that are water-soluble, are preferred since these solvents hinder and/or prevent the contact of the binder materials in the transfer medium with the final substrate during the heat transfer process. Solvents or humectants that are solid at ambient temperature may be used in one embodiment. These solvent or humectants ingredients solidify upon evaporation of the ink carrier, which may be water, forming a “blocking” film over the transfer medium, without being absorbed into the medium.

In one embodiment, the image transfer medium comprises compounds from either of the reactive chemical groups, to set up a reaction with the other group, which is contained in the ink. In one embodiment, the binder layer of the transfer medium comprises polyisocyanate compounds. The binder layer may comprise a plasticizer, such as phthalates or adipates, to impart increased flexibility to the substrate. The binder layer may comprise polymeric material. In a preferred embodiment, a protective release layer, which may comprise waxes or polymers, may be present between the binder layer and the base of the transfer medium.

In one other embodiment, the image receiving transfer medium comprises a white colorant or an encapsulated white colorant, which may be inorganic, such as TiO₂, ZnO₂, CaCO₃ or organic, or the image transfer medium may comprise a latent image material, or an electronic signaling material, such as Radio Frequency Identification Device (RFID) micro- or nano-material. After the resist layer is generated, a white, latent, or electronic signal image may then be produced on the final substrate with or without the color ink or toner image material.

When the binder layer comprises reactive materials or chemicals such as epoxy, epoxide, isocyanate/polyisocyanate, whether unblocked or blocked (including internally blocked), the ink or toner or resist layer may also comprise a co-reactant that reacts with the reactive materials in the binder layer. During the heat transfer process, the resist layer, ink or toner reacts with the reactive materials in the binder layer and prevents further reaction or bonding with the final substrate. The ingredients or chemicals in the resist layer, ink or toner may have a faster reaction rate than the reaction rate of the substrate material and the reactive ingredients in the binder layer. For example, primary amine chemicals such as certain polyethylenimine resins used in the resist layer may react with epoxide ingredients in the binder layer at a faster rate when polyamide is used as the final substrate.

When an ink jet digital printing device is used, the viscosity of the resist layer material must be appropriate to allow the ink to be printed by the inkjet printer. The viscosity of the ink is preferred to be in the range of 1-50 centipoise, and may be 3-20 centipoise. Viscous ink outside the preferred range may result in printing difficulties, poor ink droplet size/shape forming and control, and/or damaged print orifices to the ink jet printer.

Other additives such as surfactants may be used to further adjust properties of the inks such as surface energy, interfacial energy, wetting ability, bleed control, ink droplet forming, and drying ability. Polymeric dispersants or emulsifying chemicals may also be used to further enhance the storage stability or shelf life of the ink. Radiation active ingredients and corresponding radiation initiating chemicals, or radiation sensitizers, may also be used in either or both of the binder layer and resist layer-forming inks. Preferably, the surface energy of the final ink jet ink should be between 20 to 65 dyne/cm.

In yet another embodiment of the invention, the base sheet and the binder layer may be combined as a cast plastic film, as long as the mechanical strength of the material suffices the imaging process requirement. Colorant, including white pigment, various dyes and pigment, microscopic electronic sensors, latent colorant, radiation reflective materials such as microscopic glass beads, may also be included in the cast film. Thermoplastic materials such as ethylene-vinyl acetate, polyvinyl chloride, polyacrylic resin, thermoplastic polyester resin, thermoplastic polyamide, and their copolymer, terpolymer, or a combination of these materials, may be used as the film material. Chemically reactive compound such as isocyanate, polyisocyanate, epoxy, anhydride, in the form of polymers or pre-polymers, may be included as a portion of the film ingredients. The resist layer, therefore, may be printed on either or both sides of the film, adding a complex imaging feature. For example, a white-pigmented image transfer film with color inks printed on the front side but resist layer printed on the back side can create a white background color image on a dark final substrate. Images so generated improve the “hiding” ability of the dark substrate, and an intense color image on the surface, which is free from the overprint at any non-image areas. Other additives, binders, non-thermoplastic ingredients, reactants or co-reactants may be included in forming the film substrate. Optionally, surface conditioning layers on either or both sides of the film may be coated or applied for better image quality and performance.

The final substrate may be textile substrate materials containing hydroxyl groups and/or primary or secondary amino groups that react with the free isocyanate. Such materials include cotton, secondary cellulose acetate, rayon, wool, silk, and polyamides such as nylon 6, nylon 6.6 or nylon 12.

What is claimed is:

1. A method of printing an image comprising,
printing an image on a transfer medium, wherein said transfer medium comprises a binder layer for binding said image to a substrate upon transfer of said image to said substrate, and wherein said image is printed over said binder layer and said image covers a portion of said binder layer but does not cover all of said binder layer;
printing a resist layer on said transfer medium to cover substantially all of said binder layer that is not covered by said image; and
transferring said image to said substrate, wherein said resist layer inhibits a transfer to said substrate of said binder layer that is not covered by said image.

2. A method of printing an image as described in claim 1, wherein said resist layer is printed by a digital printer.

3. A method of printing an image as described in claim 1, wherein said image is printed by a digital printer.

4. A method of printing an image as described in claim 1, wherein said resist layer comprises a water insoluble material.

5. A method of printing an image as described in claim 1, wherein said resist layer comprises a water insoluble material and granular material.

6. A method of printing an image as described in claim 1, wherein said image is formed by an ink that is printed on said substrate, and wherein said ink comprises sublimation dye.

7. A method of printing an image as described in claim 1, wherein said image is formed by an ink that is printed on said substrate, and wherein said ink comprises reactive components that react when said image is transferred to said substrate.

8. A method of printing an image as described in claim 1, wherein said image is formed by an ink that is printed on said substrate, and wherein said ink comprises reactive components that react when energy is applied to said image.

9. A method of printing an image as described in claim 1, wherein said resist layer is printed by an ink jet printer.
